(19) United States
(12) Patent Application Publication
(10) Pub. No.: US 2026/0024100 A1
(43) Pub. Date: Jan. 22, 2026

(54) VERIFIED SIGNATURES, SKETCHES, AND CUSTOM COLORWAYS

(71) Applicant: DSTLRY Media, Inc., New York, NY (US)

(72) Inventors: David Steinberger, New York, NY (US); James C. Jackson, Cornwall, NY (US)

(21) Appl. No.: 19/274,781

(22) Filed: Jul. 21, 2025

Related U.S. Application Data
(60) Provisional application No. 63/674,084, filed on Jul. 22, 2024.

(51) Int. Cl. G06Q 30/018; G06K 7/14

(52) U.S. Cl. CPC G06Q 30/0185; G06K 7/1417

(57) ABSTRACT

Disclosed is a digital marketplace for digital collectibles. A digital collectible mobile application is operable to generate a QR code representing ownership of a digital collectible. Another instance of the digital collectible mobile application executed on a verified creator's device is operable to scan the QR code, display the digital collectible representing ownership of the digital collectible on the verified creator's device. A signing and design application of the digital collectible mobile application is operable to capture one or more of the following from the verified creator's device: a digital signature, a digital sketch, or a custom colorway for three dimensional digital collectibles, to generate a modified digital collectible, upload the modified digital collectible to a server. A transaction of the modified digital collectible is recorded on a secure ledger and the digital collectible's status is updated in a digital marketplace.

### CROSS-REFERENCE TO RELATED APPLICATIONS

This application claims priority to U.S. Provisional Patent Application No. 63/674,084 filed on Jul. 22, 2024, the entire contents of which are hereby incorporated by reference.

### BACKGROUND

Digital collectibles are gaining in popularity and also monetary value. Customization and authentication of digital collectibles drives popularity and the value of the digital collectible, which also may be referred to as a digital asset. Examples of digital collectibles include but are not limited to digital comics, art toys, statues, and related items, with verifiable signatures, sketches, and custom colorways (color overlay on a statue or art toy) from creators.

This is particularly useful when a creator is at a festival or other type of gathering of digital collectible enthusiasts (i.e., collectors). Creators are able to autograph or otherwise, customize a collector's digital collectable made by the respective creator, and the creator does not have to be concerned that the presented digital collectible is a forgery or deep fake of the digital collectible.

### SUMMARY

In one aspect, a method is disclosed that includes receiving a QR code from a collector, wherein the QR code is related to a specific edition of a digital collectible, interpreting the collector's QR code via a specialized application to obtain information related to the specific edition of the digital collectible, querying a server to retrieve the specific edition of the digital collectible, receiving the specific edition of the digital collectible, and modifying the specific edition of the digital collectible. The modifying includes one or more of: signing the digital collectible, sketching on the digital collectible, or customizing the colorway of the digital collectible. The modified specific edition of the digital collectible may be uploaded to the server. A transaction may be recorded in a secure ledger. The recorded transaction in the secure ledger may include an edition number, a verified signer identifier, the date and time of the signing, and/or a type of modification made to the modified specific edition of the digital collectible.

A system for customizing three dimensional digital collectibles is disclosed. The system includes: one or more processors, a user interface for displaying three dimensional models of digital collectibles and for saving and naming custom colorways, a database for storing and retrieving the named custom colorways, editing tools for applying colors, textures, and patterns to the three-dimensional models of the digital collectibles. The editing tools have access to the named custom colorways in the database, and the one or more processors may be configured execute the user interface and the editing tools, and access a digital marketplace for selling the customized, three-dimensional digital collectibles.

### BRIEF DESCRIPTION OF THE DRAWINGS

To easily identify the discussion of any particular element or act, the most significant digit or digits in a reference number refer to the figure number in which that element is first introduced.

FIG. 1 illustrates an exemplary data flow process for utilizing a digital collectible signing application according to the disclosed subject matter.

FIG. 2 illustrates an exemplary flow process for utilizing a digital collectible marketplace application according to the disclosed subject matter.

FIG. 3 illustrates an exemplary process implementation of the disclosed subject matter.

FIG. 4 illustrates a block diagram of an exemplary system to implement the disclosed subject.

### DETAILED DESCRIPTION

The disclosed subject matter provides a platform for digital collectible enthusiasts and creators to interact, allowing for the creation of unique, verified digital collectibles. The system utilizes QR codes or other secure communication techniques, such as radio-frequency identification, near-field communication (NFC), and the like, for physical verification, a specialized signing and design application, and a secure ledger to create and authenticate signed, sketched, or customized digital collectibles.

The presently disclosed subject matter relates to a system and method for creating, authenticating, and trading digital collectibles, including but not limited to digital comics, art toys, statues, and related items, with verifiable signatures, sketches, and custom colorways (color overlay on a statue or art toy) from creators.

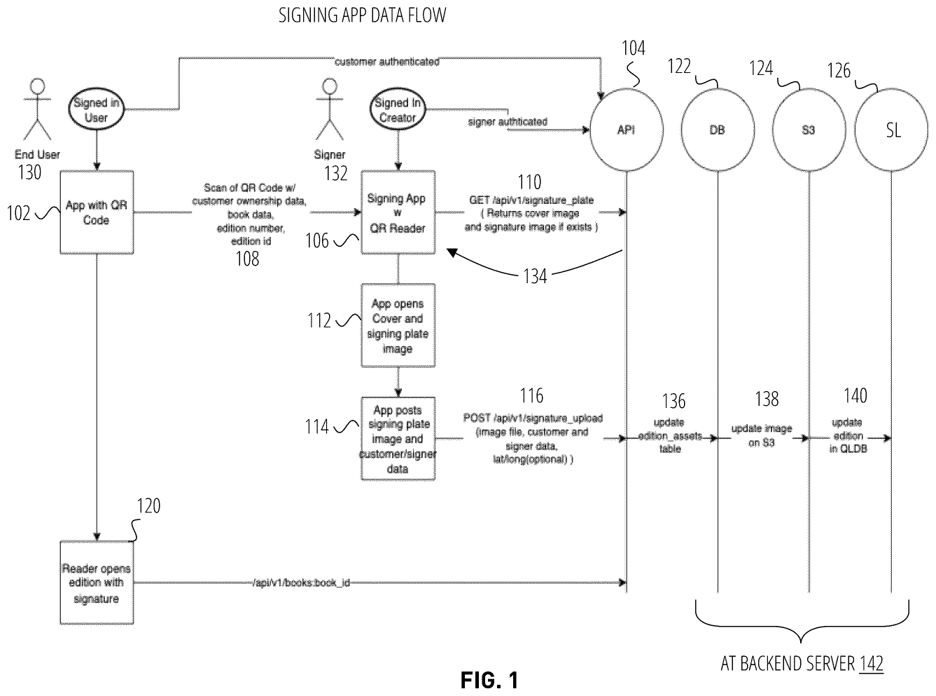

FIG. 1 illustrates an exemplary data flow process for utilizing a digital collectible signing application according to the disclosed subject matter.

At 102, an end user 130 may sign into their digital collection via a specialized digital collectible mobile application executing on a mobile device of the end user 130. The mobile device may be a smartphone, laptop, tablet, or the like. The end user 130 may request a QR code to be generated that is usable to authenticate the end user 130 as a verified owner. The digital collectible mobile application may generate a QR Code for the end user 130. The end user 130 may be presented with two options of QR code. The QR code includes a location in a digital collectible storage, such as database 122 or ledger database 126, where the digital collectible referenced by the QR code is located.

The two types of QR codes may be 1) a general ownership QR code representing the user's entire collection, and 2) a specific QR code for each of the individual digital collectibles owned by a customer (e.g., digital comics including limited and/or numbered editions, digital art toys, digital statues, digital figurines, and the like). The general ownership QR code may require additional input for selection of a specific edition(s) from the user's entire collection that the user requests to be modified by the creator 132.

While QR codes are described, it is envisioned that other techniques, such as radio-frequency identification (RFID), near-field communication (NFC), or the like may be used for physical verification. For example, instead of QR code generator, a token may be generated that shared by the end user 103 with creator 132 via either RFID or NFC in a similar manner as described below with reference to the QRC code.

The end user 130 when meeting the creator 132 may present the QR code to the creator 132. The creator 132, who is a verified creator of the digital collectible, uses an instance of the digital collectible mobile application executing on the creator's mobile device, such as a smartphone, laptop, tablet, or the like. The creator, at 106, may a utilize a signing and design application that is a routine implemented via the digital collectible mobile application to scan the end user's QR code. At 110, the digital collectible mobile application is operable to query (110) a backend server via application programming interface (API) 104 with a request for the specific edition of a digital collectible or digital asset from the end user's 130 digital collection. The backend server may be operable to return (134) the specific edition (e.g., a comic cover, a 3D model of art, a toy, a figurine, or a statue). The specific edition may include a cover image and a signature image if one exists. A specific edition, or a digital collectible, may also include a digital comic cover, a three dimensional model of digital art toy, a three dimensional model of a digital statue, a three dimensional model of digital figurines, a two-dimensional illustration of a digital comic character, a two-dimensional illustration of a digital comic scene, or a two-dimensional illustration of a portion of digital comic book or strip.

At 112, a signing and design application that is a component of the digital collectible mobile application is operable to open the cover image of the specific edition and the signature image, if provided, in response to commands input by the creator 132. The signature image may be a signing plate image. The creator 132 may perform one or more of the following actions: signs the digital asset, sketches on the digital asset, and/or customizes the colorway of the digital asset (for 3D objects like art toys and statues). Examples of specific editions may include a digital comic cover, any page of a digital comic, a three dimensional model of digital art toy, a three dimensional model of a digital statue, a three dimensional model of digital figurines, a digital two-dimensional illustration of a digital comic print, digital poster, digital cards, a digital two-dimensional illustration of a digital comic scene or digital comic page, or a two-dimensional illustration of a portion of digital comic book or strip

At 114, the modified digital asset for the specific edition is uploaded to the server. For example, the digital collectible mobile application may post (116) the modified signing plate image and end user and creator data via the API 104. At the backend server 142, a database 122 containing a listing of the digital collectibles in the end user's 130 collection is updated to indicate the modified digital asset. Modifications may include identifying the action taken by the creator 132 at 112. The image of the digital collectible may be updated in a secure environment, such as an object storage service or the like (138).

To ensure authenticity and support appropriate valuation of the modified digital collectible, a transaction is recorded on a secure ledger database 126. The recorded transaction may include an edition number, a verified signer identification, and type of modification. The secure ledger database 126 may incorporate blockchain techniques to ensure secure storage and accurate verification.

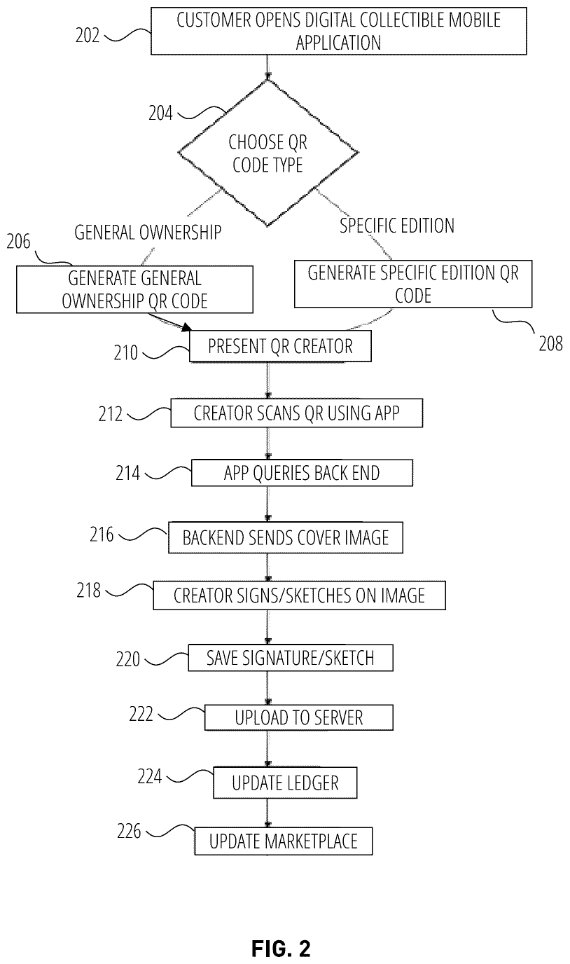

FIG. 2 illustrates an exemplary flowchart for utilizing a digital collectible mobile application according to the disclosed subject matter.

An end user, such as end user 130 of FIG. 1, utilizes a digital collectible mobile application to access a marketplace for digital assets that includes digital collectibles, such as digital comics including limited and/or numbered editions, digital art toys, digital statues, digital figurines, and the like (202). The end user has the option to have a QR code generated at 204. The QR code represents ownership of a digital collectible. The end user selects between a general ownership QR code 206 or an edition-specific QR code 208. If the general ownership QR code is selected, at 206, a general ownership QR code is generated. If an edition-specific QR code is selected, at 208, an edition-specific QR code is generated. Whichever QR code is selected, the QR code identifies a digital collectible, for example, a specific edition of digital collectible in the end user's collection, selected by the end user to be signed or modified by the creator. For example, a cover image of a comic, or 3D model of a digital figurine may be identified by the QR code. In an example, a cover is a two-dimensional (2D) image, and a 3D model has a color “wrap” that is flattened into 2D to draw on by the creator 132. The QR code includes location information, version information, or edition information.

The end user presents the selected QR code to a creator, such as creator 132, at 210.

At 212, the creator scans the QRC code using a mobile device executing an instance of the digital collectible mobile application. The digital collectible mobile application including a signing and design application is operable to interpret the collector's QR code to obtain information related to the specific edition of the digital collectible identified by the QR code. The digital collectible mobile application queries a backend server (214).

In response to the query, the backend server retrieves and sends (216), for example, the cover image indicated by the collector's QR code to the digital collectible mobile application executing on the creator's mobile device.

In 218, a signing and design application component of the digital collectible mobile application displays the digital collectible on the creator's device and captures one or more of the following from the creator: a digital signature, a digital sketch, and/or a custom colorway for 3D digital collectibles.

At 220, the signed, sketched, or otherwise modified digital collectible is saved in a secure database and a log is updated regarding the modification to the digital collectible.

At 222, the modified digital collectible is uploaded to the server, and a transaction representing the modification to the digital collectible is recorded on a secure ledger (224). The transaction may include an edition number of the digital collectible, the type of modification/change (e.g., signature, sketch, color way), a verified creator ID, a date, and a time of the modification/change. The verified creator ID is an identifier that is verifiable and that uniquely and securely identifies the creator.

In 226, the digital collectible's status is updated in a digital marketplace. The status may, for example, include an indication of modifications made to the modified digital collectible.

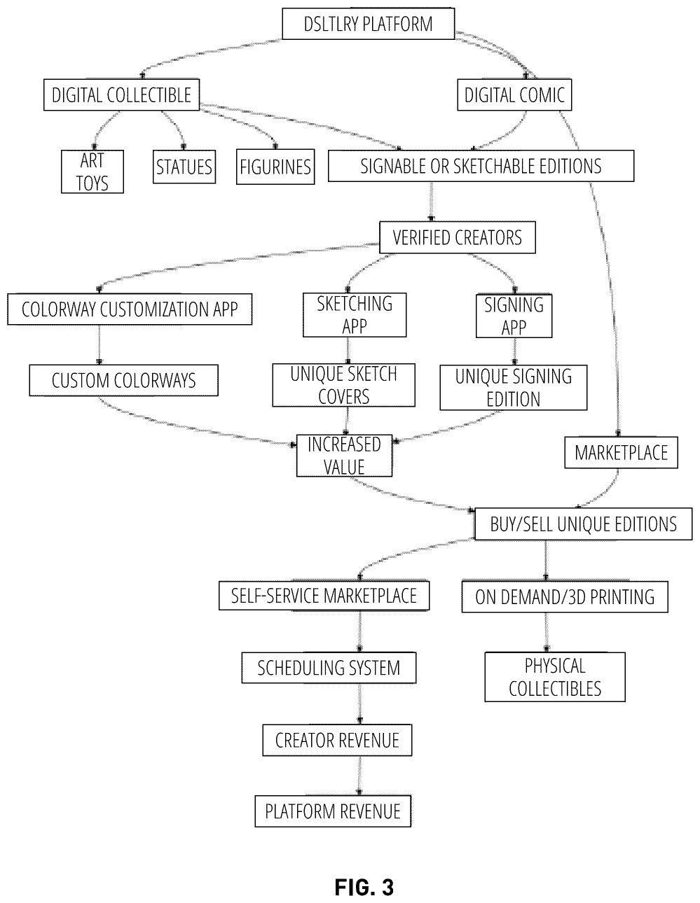

FIG. 3 illustrates an exemplary process implementation of the disclosed subject matter.

Process implementation includes additional details of the above processes and also additional features. Some of those additional features include, for example, an expanded creator verification system, a scheduling system for creator signing/sketching/customization sessions, an augmented reality (AR) visualization of customized editions of 3D collectibles, geo-located shareable versions, and art print-on-demand or 3D printing functionality for physical versions of the digital collectibles.

In the example, the expanded creator verification system may include implementations that allow expanding the signing and design application used by the creator to add photographic or video recording of the creator stating name and edition number or other interesting information about the digital collectible. Additionally, a function that enables a time lapse recording of the creator's signature as it is drawn, to show the creator's signature in animated version on the edition of the digital collectible.

Also, in digital collectible convention settings, it may be difficult for a creator to meet all of their fans and to customize an end user's digital collectible, so it would be beneficial if the digital collectible mobile application had scheduling functionality to enable scheduling appointments with end users.

Also, shown in a self-serve marketplace that may be implemented via a digital collectible marketplace application. In the self-serve marketplace, creators may present their creations and end users can review and purchase the creations. The scheduling functionality may also be part of the self-serve marketplace to permit end user scheduling requests with respective creators. The self-serve marketplace may also be operable to calculate creator revenue as well as determine platform revenue.

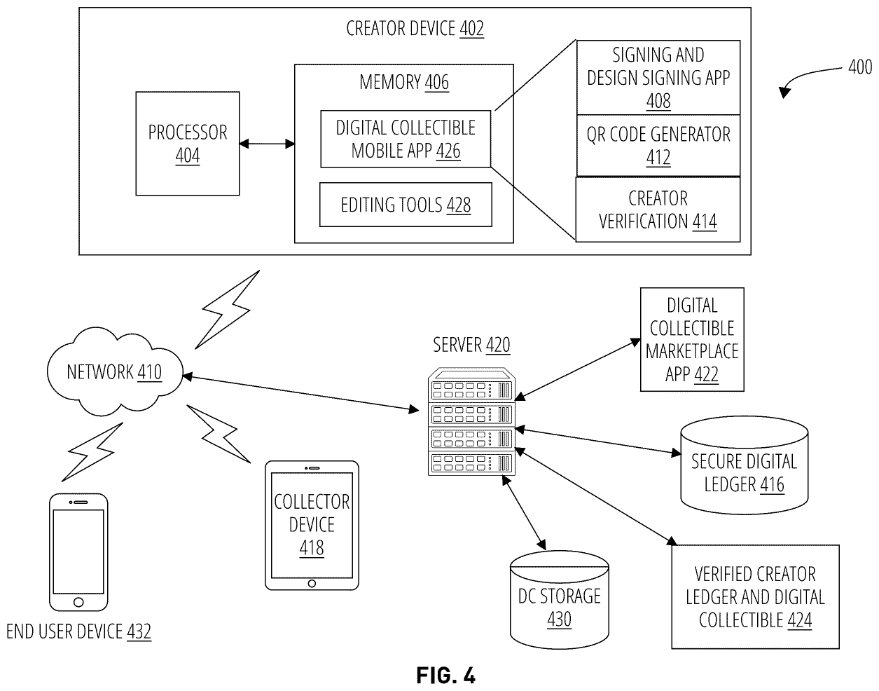

FIG. 4 illustrates a block diagram of an exemplary system to implement the disclosed subject matter.

The system 400 includes elements to implement the functionality and processes described with reference to the examples of FIGS. 1-3.

The system 400 comprises a creator device 402, a network 410, a secure digital ledger 416, a server 420, a digital collectible marketplace application 422, a verified creator ledger and digital collectible 424, a digital collectible mobile application 426, an editing tools 428, a DC storage 430, and an end user device 432.

The creator device 402 may be a mobile device, such as a smartphone, tablet, laptop, or the like, and includes a processor 404, a memory 406, a signing and design application 408, a QR code generator 412, as well as a creator verification 414 routine. The signing and design application 408 is available only to creators verified via the creator verification 414 routine and is operable to enable the creator to digitally sign, sketch, generate a colorway for a digital collectible, or otherwise modify a digital collectible created by the verified creator.

The collector device 418, like the end user device 432 and the creator device 402, is operable to execute an instance of the digital collectible mobile application 426 and perform the functions described with reference to the examples of FIGS. 1 and 2.

In a further example, an end user, such as 130, may use the digital collectible mobile application 426 to access their collection of digital collectibles, as shown in FIG. 1 at 120. The digital collectible mobile application 426 may provide an additional feature such as a sketch cover coloring option. In this option, the end user 130 may be able to sketch on a cover of a digital comic. In a process flow example, the end user may own one or more editions of a sketch cover book as defined by backend as “sketchable.” The end user 130 via the digital collectible mobile application 426 is directed to the API 104 and gains access via an authentication routine to 122, 124, and/or 126 to retrieve the collection of digital collectibles.

Once the collection is presented to the end user 130, the end user 130 navigates to the specific edition they select to sketch in. As mentioned above, the end user device, such as 432 or collector device 418, include displays and input devices, such as touchscreens, that present the digital collectible and functional user interface elements (such as sell button, a sign button, a sketch button, or the like) that enable the end user 130 to perform a number of functions, such as sketch, sell, buy and the like).

Continuing with the cover sketch example process, the system may be operable to enable the end user 130 to select the sketch button. In response to selection of the sketch button, the end user 130 is presented with a JavaScript-based (or the like) drawing app with the background being the sketch cover image of the book. This may enable the end user 130 to draw on the cover and save, which submits a sketch image of the drawn-on cover to API 104. The sketch image is stored on a user assets S3 bucket at 124. The sketch image is referenced from an editions table (i.e., database, data structure or the like), for example, in DB 122 and in ledger database 126 (e.g., secure digital ledger 416).

There is also a reader application that enables the end user 130 to read the digital collectibles in their collection. Similar to accessing their collection as described above, the User, via a detailed view path, opens collection and navigates to the sketch cover colored edition. For example, the user clicks a READ button presented, for example, on the cover—this READ button may trigger a check for edition specific content. Once in the reader path, the end user 130 may open a book from their collection just like they always would. In the example, the user opens a control panel by clicking in the center of the screen. Additionally, the user may be presented with dropdown of edition list and views Sketch Artist Image as cover.

As an owner of a sketch cover digital comic, the may like to have a Sketch Artist color the cover of my edition,

In a further example, which involves an end user 130, who is owner of an edition of a book similar to those described with reference to FIG. 1. The digital collectible may include a Sketch Image, which is an image created by coloring in cover. In this example, in addition to a creator 132, the end user 130 may engage a sketch artist, who is able to create a sketch image using a sketch artist application for drawing on top of specific edition cover image.

In the example, the end user 130 owns one or more editions of a sketch cover book as defined by backend server 142 as “sketchable.” The end user 130 accesses their collection and navigates to the specific edition they want to sketch in. The user is presented with a SKETCH button along with other options. The user selects a SKETCH option, which enables a QR code generator to generate a QR Code with edition information that delivered to user to share with the Sketch Artist. The sketch artist may scan the User's QR code in Sketch Artist App and access the selected specific edition. In response to the QR code being scanned, the Sketch Artist App is presented with the background layer of the edition cover. The sketch artist application is a drawing application. The sketch artist draws a cover for this specific edition, and saves, which submits the image to the API and the backend server 142 for storage as a unique asset along side edition information. The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Indeed, the terms “processor,” “controller,” and the like, are generally used interchangeably herein, and refer to any of the above devices and systems, as well as any data processor.

While this specification contains many specific implementation details, these should not be construed as limitations on the scope of any disclosed subject matters or of what may be claimed, but rather as descriptions of features specific to particular implementations of particular disclosed subject matters. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations. Furthermore, it should be understood that the described program components and systems may, optionally, be integrated together into a single software product or packaged into multiple software products.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips, FPGAs), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the subject matter disclosed herein. It is intended that the specification and examples be considered as exemplary only, with a true scope and spirit of the disclosed subject being indicated by the following claims.

What is claimed is:

1. A method for creating verified digital collectibles, comprising:
scanning an end user QR code via a digital collectible mobile application executing on a verified creator's device;
displaying a digital collectible identified by the end user QR code on the verified creator's device;
capturing one or more of the following from the verified creator's device: a digital signature, a digital sketch, or a custom colorway for three dimensional digital collectibles, to generate a modified digital collectible;
uploading the modified digital collectible to a server;
recording a transaction of the modified digital collectible on a secure ledger; and
updating a digital marketplace by indicating a status of the modified digital collectible.

2. The method of claim 1, wherein the indicated status includes an indication of modifications made to the modified digital collectible.

3. The method of claim 1, wherein the recorded transaction in the secure ledger includes an edition number, a verified signer identifier, and a type of modification made to the modified digital collectible.

4. The method of claim 1, wherein the digital collectible is selected from a group comprising: digital comics, digital art toys, digital statues, or digital figurines.

5. A non-transitory computer-readable storage medium, the computer-readable storage medium including instructions that when executed by a processor, cause the processor to:
generate a QR code representing ownership of a digital collectible;
scan the QR code with a verified creator's device;
display the digital collectible on the verified creator's device;
capture one or more of the following from the verified creator's device: a digital signature, a digital sketch, or a custom colorway for three dimensional digital collectibles, to generate a modified digital collectible;
upload the modified digital collectible to a server;
record a transaction of the modified digital collectible on a secure ledger; and
updating a digital marketplace by indicating a status of the modified digital collectible.

6. The computer-readable storage medium of claim 5, wherein the recorded transaction in the secure ledger includes an edition number, a verified signer identifier, a date, and a time of when the modification was made to the modified digital collectible, and a type of modification made to the modified digital collectible.

7. The computer-readable storage medium of claim 5, wherein the digital collectible is selected from the group of: digital comics, digital art toys, digital statues, and digital figurines.

8. A system for customizing three dimensional digital collectibles, comprising:
a user interface for displaying three dimensional models of digital collectibles and for saving and naming custom colorways;
a database for storing and retrieving named custom colorways;
editing tools for applying colors, textures, and patterns to the three-dimensional models of the digital collectibles, wherein the editing tools have access to the named custom colorways in the database; and
one or more processors configured to execute the user interface and the editing tools and access a marketplace for selling customized three-dimensional digital collectibles.

9. The system of claim 8, wherein the one or more processors are operable to:
receive a QR code from a collector, wherein the QR code is related to a specific edition of a digital collectible;
interpret the collector's QR code via a specialized application to obtain information related to the specific edition of the digital collectible, the information includes location information, version information, or edition information;
query a server to retrieve the specific edition of the digital collectible;
receive, in response to the query, the specific edition of the digital collectible from the server; and
modify the specific edition of the digital collectible.

10. The system of claim 9, wherein modifying the specific edition of the digital collectible includes one or more of: signing the digital collectible, sketching on the specific edition of the digital collectible, or customizing a colorway of the digital collectible.

11. The system of claim 8, wherein the one or more processors are operable to:
modify the specific edition of the digital collectible;
upload a modified specific edition of the digital collectible to a server; and
record a transaction in a secure ledger, wherein the recorded transaction in the secure ledger includes an edition number, a verified signer identifier, and a type of modification made to the modified specific edition of the digital collectible.

12. The system of claim 8, wherein the specific edition is a digital comic cover, any page of a digital comic, a three dimensional model of digital art toy, a three dimensional model of a digital statue, a three dimensional model of digital figurines, a digital two-dimensional illustration of a digital comic print, digital poster, digital cards, a digital two-dimensional illustration of a digital comic scene or digital comic page, or a two-dimensional illustration of a portion of digital comic book or strip.

13. A method, comprising:
receiving a QR code from a collector, wherein the QR code is related to a specific edition of a digital collectible;
interpreting the collector's QR code via a specialized application to obtain information related to the specific edition of the digital collectible, the information includes location information, version information, or edition information;
querying a server to retrieve the specific edition of the digital collectible;
receiving the specific edition of the digital collectible; and
modifying the specific edition of the digital collectible, wherein modifying includes one or more of: signing the digital collectible, sketching on the specific edition of the digital collectible, or customizing a colorway of the digital collectible.

14. The method of claim 13, further comprising:
uploading the modified specific edition of the digital collectible to the server; and
recording a transaction in a secure ledger, wherein the recorded transaction in the secure ledger includes an edition number, a verified signer identifier, and a type of modification made to the modified specific edition of the digital collectible.

15. The method of claim 13, wherein the specific edition is a digital comic cover, any page of a digital comic, a three dimensional model of digital art toy, a three dimensional model of a digital statue, a three dimensional model of digital figurines, a digital two-dimensional illustration of a digital comic print, digital poster, digital cards, a digital two-dimensional illustration of a digital comic scene or digital comic page, or a two-dimensional illustration of a portion of digital comic book or strip.
